(19) United States
(12) Patent Application Publication
(10) Pub. No.: US 2015/0350051 A1
(43) Pub. Date: Dec. 3, 2015

(54) Quickly locating devices

(71) Applicant: International Business Machines Corporation, Armonk, NY (US)

(72) Inventors: Marylin Ann Lincoln, Wake Forest, NC (US); Muhammad Arif, Raleigh, NC (US); Joel Duquene, Raleigh, NC (US); Morris Stanley Johnson, JR., Cary, NC (US)

(73) Assignee: International Business Machines Corporation, Armonk, NY (US)

(21) Appl. No.: 14/294,289

(22) Filed: Jun. 3, 2014

(51) Int. Cl. H04L 12/26; H04L 29/08

(52) U.S. Cl. CPC H04L 43/10; H04L 67/18

(57) ABSTRACT

A set of computing devices are networked together. Each device maintains data about the other computing devices in the set, namely, a time and location of a last successful connection between the device and one or more of the other devices. The data at a device is updated as computing devices in the set move out of communication range with one another, for example (a) when the particular computing device itself loses contact with one of the other computing devices in the set, or (b) when the particular computing device receives a notification from one of the other computing devices that such other computing device has lost contact with a computing device that the other computing device had been in contact with. The connection table data is then used to locate a lost computing device, or the identity of a device that has such information in its connection table.

### BACKGROUND OF THE INVENTION

1. Technical Field

This disclosure relates generally to locating mobile devices.

2. Background of the Related Art

The recent past has seen an enormous growth in the usage and capabilities of mobile devices, such as smartphones, tablets, and the like. Such devices comprise fast processors, large amounts of memory, gesture-based multi-touch screens, and integrated multi-media and GPS hardware chips. Many of these devices use open mobile operating systems, such as Android. The ubiquity, performance and low cost of mobile devices have opened the door for creation of a large variety of mobile applications.

Personal devices of this type, however, are becoming smaller and also easier to misplace. It is not always easy to locate them, or the location where they may have been misplaced may have exceeded the range of the embedded transmission device. Also, the device battery may have become too weak to operate and send signals that would facilitate its recovery. As an example, users often make use of a Bluetooth technology headset for their smartphones. If the user misplaces the headset outside of the home, for example, it may become hard to locate the device and also to find out where it was misplaced. If the user is outside of the range of the headset, it may not be possible to use Bluetooth technology to locate it. The problem is exacerbated in the scenario where the user has multiple computing devices (e.g., a smartphone, and a tablet) that connect to the headset, or where the lost device is shared among multiple users each having their own computing device.

### BRIEF SUMMARY

According to this disclosure, a set of computing devices (e.g., mobile devices) are assumed to be networked together (i.e., in communication range) and keep track of one another. Each computing device in the set executes an application (e.g., a mobile app) that maintains data about the other computing devices in the set and, in particular, a time and location of a last successful connection between the computing device and one or more of the other computing devices. The data at a particular computing device is updated as computing devices in the set move out of communication range with one another. In particular, preferably the data at the particular computing device is updated (a) when the particular computing device itself loses contact with one of the other computing devices in the set, or (b) when the particular computing device receives a notification from one of the other computing devices that such other computing device has lost contact with a computing device that the other computing device had been in contact with. In this manner, the particular computing device in the set obtains a time and location of some last successful connection with respect to some other computing device in the set even if the latter computing device is not (or indeed never was) directly connected to the particular computing device. Stated another way, the computing devices that are networked together share (among each other) “last successful connection” data indicating when a particular computing device in the set last had a successful connection to some other computing device.

Subsequently, and upon receipt of a request to locate a lost computing device that is one of the set of computing devices, an exact or last known location of the lost computing device is identified using the updated data maintained at the device that receives the request. This updated data identifies the location either directly (when the computing device that receives the request had the last successful connection to the lost computing device), or indirectly, by identifying a second computing device that had a last successful connection to the lost computing device. If the computing device that receives the request to locate the lost computing device does not have the most current location information for the lost computing device, it then queries the second computing device to obtain the last known location of the lost computing device.

Preferably, the mechanism is implemented in software executing on each computing device, and each computing device includes communication technologies that provide for the network connectivity.

The foregoing has outlined some of the more pertinent features of the disclosed subject matter. These features should be construed to be merely illustrative. Many other beneficial results can be attained by applying the disclosed invention in a different manner or by modifying the disclosed subject matter as will be described.

### BRIEF DESCRIPTION OF THE DRAWINGS

For a more complete understanding of the disclosed subject matter and the advantages thereof, reference is now made to the following descriptions taken in conjunction with the accompanying drawings, in which:

FIG. 1 depicts an exemplary block diagram of a representative mobile device in which the techniques of this disclosure may be implemented;

FIG. 2 is an exemplary block diagram of a data processing system in which exemplary aspects of the illustrative embodiments may be implemented;

FIG. 3 illustrates a set of computing devices that each include a connection table identifying a time and location of a last successful connection between the computing device and one or more of the other computing devices in the set;

FIG. 4 illustrates how the connection tables (in FIG. 3) are updated as connectivity changes occur across the set of computing devices;

FIG. 5 illustrates a process flow illustrating an embodiment of this disclosure whereby a computing device locates a lost device using connection table data stored in the networked computing devices; and

FIG. 6 illustrates a variant scenario from FIG. 5 that occurs when none of the computing devices connected to the requesting computing device (the device seeking to find the lost device) are currently connected to the lost device.

### DETAILED DESCRIPTION OF AN ILLUSTRATIVE EMBODIMENT

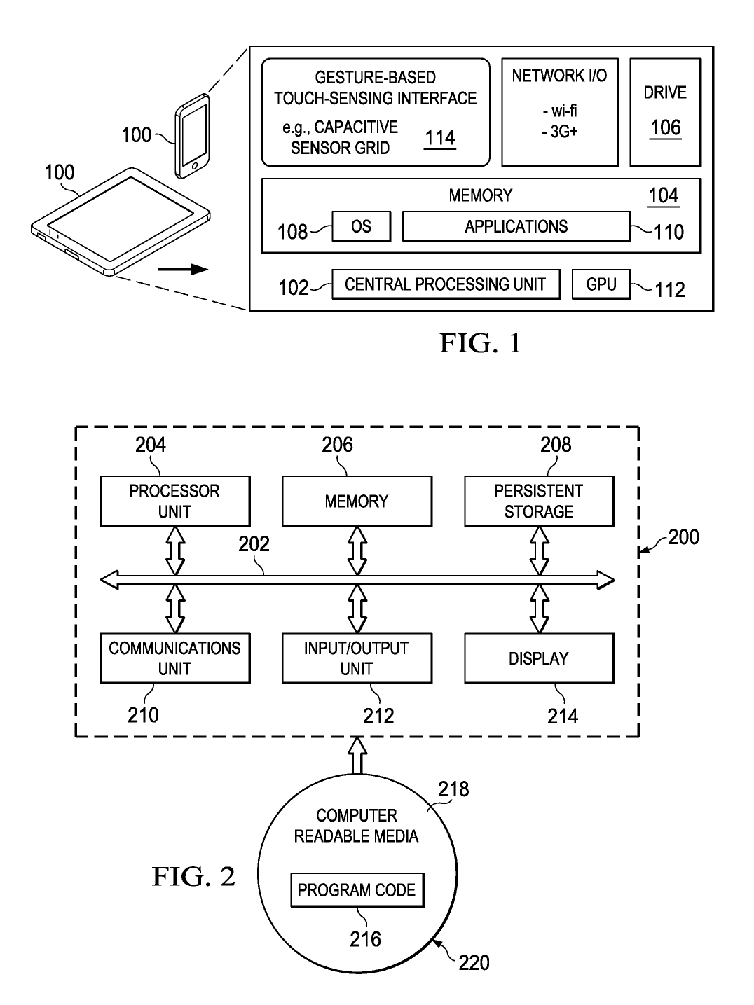

With reference now to the drawings and in particular with reference to FIGS. 1-2, exemplary diagrams of data processing environments are provided in which illustrative embodiments of the disclosure may be implemented. It should be appreciated that FIGS. 1-2 are only exemplary and are not intended to assert or imply any limitation with regard to the environments in which aspects or embodiments of the disclosed subject matter may be implemented. Many modifications to the depicted environments may be made without departing from the spirit and scope of the disclosed subject matter.

FIG. 1 illustrates representative mobile devices, namely, a smartphone 100, and a tablet device 102. As is well-known, such devices typically comprise fast processors, large amounts of memory, gesture-based multi-touch screens, and integrated multi-media and GPS hardware chips. Many of these devices use open mobile operating systems, such as Android. The ubiquity, performance and low cost of mobile devices have opened the door for creation of a large variety of mobile applications including, without limitation, applications that require or take advantage of cryptographic operations. Such operations may be associated with a particular application, or the device operating system itself. As will be described, the techniques herein may be implemented with respect to any computing entity application.

With reference now to FIG. 2, a block diagram of an exemplary data processing system is shown in which aspects of the illustrative embodiments may be implemented. Data processing system 200 is an example of a computer, such as mobile device 100 or 102 in FIG. 1, in which computer usable code or instructions implementing the processes for illustrative embodiments of the disclosure may be located.

With reference now to FIG. 2, a block diagram of a data processing system is shown in which illustrative embodiments may be implemented. Data processing system 200 is an example of a computer, such as a mobile device of FIG. 1, in which computer-usable program code or instructions implementing the processes may be located for the illustrative embodiments. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems in which a main processor is present with secondary processors on a single chip. As another illustrative example, processor unit 204 may be a symmetric multi-processor system containing multiple processors of the same type.

Memory 206 and persistent storage 208 are examples of storage devices. A storage device is any piece of hardware that is capable of storing information either on a temporary basis and/or a permanent basis. Memory 206, in these examples, may be, for example, a random access memory or any other suitable volatile or non-volatile storage device. Persistent storage 208 may take various forms depending on the particular implementation. For example, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. In these examples, communications unit 210 is a network interface card. Communications unit 210 may provide communications through the use of either or both physical and wireless communications links.

Input/output unit 212 allows for input and output of data with other devices that may be connected to data processing system 200. For example, input/output unit 212 may provide a connection for user input through a keyboard and mouse. Further, input/output unit 212 may send output to a printer. Display 214 provides a mechanism to display information to a user.

Instructions for the operating system and applications or programs are located on persistent storage 208. These instructions may be loaded into memory 206 for execution by processor unit 204. The processes of the different embodiments may be performed by processor unit 204 using computer implemented instructions, which may be located in a memory, such as memory 206. These instructions are referred to as program code, computer-usable program code, or computer-readable program code that may be read and executed by a processor in processor unit 204. The program code in the different embodiments may be embodied on different physical or tangible computer-readable media, such as memory 206 or persistent storage 208.

Program code 216 is located in a functional form on computer-readable media 218 that is selectively removable and may be loaded onto or transferred to data processing system 200 for execution by processor unit 204. Program code 216 and computer-readable media 218 form computer program product 220 in these examples. In one example, computer-readable media 218 may be in a tangible form, such as, for example, an optical or magnetic disc that is inserted or placed into a drive or other device that is part of persistent storage 208 for transfer onto a storage device, such as a hard drive that is part of persistent storage 208. In a tangible form, computer-readable media 218 also may take the form of a persistent storage, such as a hard drive, a thumb drive, or a flash memory that is connected to data processing system 200. The tangible form of computer-readable media 218 is also referred to as computer-recordable storage media. In some instances, computer-recordable media 218 may not be removable.

Alternatively, program code 216 may be transferred to data processing system 200 from computer-readable media 218 through a communications link to communications unit 210 and/or through a connection to input/output unit 212. The communications link and/or the connection may be physical or wireless in the illustrative examples. The computer-readable media also may take the form of non-tangible media, such as communications links or wireless transmissions containing the program code. The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 2 can be varied from the illustrative examples shown. As one example, a storage device in data processing system 200 is any hardware apparatus that may store data. Memory 206, persistent storage 208, and computer-readable media 218 are examples of storage devices in a tangible form.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache such as found in an interface and memory controller hub that may be present in communications fabric 202.

Computer program code for carrying out operations of the present invention may be written in any combination of one or more programming languages, including an object-oriented programming language such as Java™, Smalltalk, Objective C, C++ or the like, and conventional procedural programming languages, such as the “C” programming language or similar programming languages. Program code may be written in interpreted languages, such as Python. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). The techniques herein may also be implemented in non-traditional IP networks.

Those of ordinary skill in the art will appreciate that the hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system, other than the SMP system mentioned previously, without departing from the spirit and scope of the disclosed subject matter.

Without limitation, the techniques described herein may operate in conjunction within mobile devices operating according to a standard client-server paradigm in which client machines communicate with an Internet-accessible server(s) executing on a set of one or more machines. In such a scenario, end users operate Internet-connectable devices (e.g., Internet-enabled mobile devices, or the like) that are capable of accessing and interacting with the server(s). Typically, each client or server machine is a data processing system such as illustrated in FIG. 2 comprising hardware and software, and these entities communicate with one another over a network, such as the Internet, an intranet, an extranet, a private network, or any other communications medium or link. Generalizing, a data processing system typically includes one or more processors, an operating system, one or more applications, and one or more utilities. The applications on the data processing system provide native support for Web services including, without limitation, support for HTTP, SOAP, XML, WSDL, UDDI, and WSFL, among others. Information regarding SOAP, WSDL, UDDI and WSFL is available from the World Wide Web Consortium (W3C), which is responsible for developing and maintaining these standards; further information regarding HTTP and XML is available from Internet Engineering Task Force (IETF). Familiarity with these standards is presumed.

### Mobile Device Technologies

As described above, mobile device technologies also are well-known. In a representative but non-limiting embodiment, a mobile device is a smartphone or tablet, such as the iPhone® or iPad®, an Android™-based mobile device, or the like. Referring back to FIG. 1, a device of this type typically comprises a CPU 102, computer memory 104, such as RAM, and a data store 106. The device software includes operating system (e.g., Apple iOS, Android, Blackberry OS, Windows Mobile, or the like) 108, and generic support applications and utilities 110. Typically, the device includes a separate graphics processing unit (GPU) 112. A touch-sensing device or interface 114, such as a capacitive touchscreen, is configured to receive input from a user's touch and to send this information to processor 112. The interface 114 responds to gestures on the touch sensitive surface. Other input/output devices include software-based keyboards, cameras, microphones, accelerometers, magnetometers, radio or WiFi mechanisms, and the like.

More generally, the mobile device is any wireless client device, e.g., a cellphone, pager, a personal digital assistant (PDA, e.g., with GPRS NIC, WiFi card, etc.), a mobile computer with a smartphone client, or the like. Typical wireless protocols are: WiFi, GSM/GPRS, CDMA or WiMax. These protocols implement the ISO/OSI Physical and Data Link layers (Layers 1 & 2) upon which a traditional networking stack is built, complete with IP, TCP, SSL/TLS and HTTP.

For example, a mobile device as used herein is a 3G- (or next generation) compliant device that may include a subscriber identity module (SIM), which is a smart card that carries subscriber-specific information, mobile equipment (e.g., radio and associated signal processing devices), a man-machine interface (MMI), and one or more interfaces to external devices. The techniques disclosed herein are not limited for use with a mobile device that uses a particular access protocol. The mobile device typically also has support for wireless local area network (WLAN) technologies, such as Wi-Fi. WLAN is based on IEEE 802.11 standards.

Generalizing, the mobile device is any wireless client device, e.g., a smartphone, a tablet, a personal digital assistant (PDA, e.g., with GPRS or WiFi-based NIC), a mobile computer with a smartphone or tablet-like client, or the like. Other mobile devices in which the technique may be practiced include any access protocol-enabled device (e.g., a Blackberry® device, an Android™-based device, or the like) that is capable of sending and receiving data in a wireless manner using a wireless protocol. Typical wireless protocols are: WiFi, GSM/GPRS, CDMA or WiMax. These protocols implement the ISO/OSI Physical and Data Link layers (Layers 1 & 2) upon which a traditional networking stack is built, complete with IP, TCP, SSL/TLS and HTTP.

Typically, computing devices such as described also implement networking technology for exchanging data over short distances, such as Bluetooth, which is a wireless technology standard that uses short-wavelength UHF radio waves in the ISM band from 2.4 to 2.485 GHz). Devices that implement Bluetooth can create personal area networks (PANs). Bluetooth can connect to several devices at once. Alternatives to Bluetooth include, without limitation, ultra wideband, induction wireless, and others.

The underlying network transport may be any communication medium including, without limitation, cellular, wireless, Wi-Fi, small cell (e.g., femto), and combinations thereof.

A computing device as described herein may not include processor but may be a simple device that just includes basic hardware and networking technology, such as a Bluetooth-based headset.

### Locating a Lost Computing Device

According to this disclosure, a set of computing devices (e.g., mobile devices) are assumed to be networked together (i.e., in communication range) and keep track of one another. Due to movement of the devices (or of the users having possession thereof), the set of computing devices typically changes dynamically over time as given one(s) of the computing devices move out of communication range with one another. There is no requirement herein that each computing device be in communication range of any number of the other computing devices in the set, although typically it will be the case each such computing device will have been in communication range of at least one such other computing device in the (typically, constantly changing) set. A computing device may include a processor and one or more software programs executing in that processor, but this is not a requirement, as a particular computing device may just include dedicated or special-purpose hardware (e.g., firmware). Each computing device of the set, however, will include an appropriate networking mechanism or technology to provide the network connectivity to one or more other computing devices (or, more generally, the underlying network transport for communications). The nature and type of the underlying network transport may vary, but typically it will be some form of wireless infrastructure, network and/or set of support devices and systems. As noted above, the particular details of the network transport are not a limitation of this disclosure, as the device location techniques herein may be used with any such transport, irrespective of the technical standard, transport medium, or otherwise. Thus, as used herein, computing devices include the appropriate networking technology that is necessary to enable them to communicate data over the underlying network transport.

According to this basic technique of this disclosure, each computing device in the set executes an application (e.g., a mobile app, a native application, an execution thread of another application having some other function, etc.) that maintains data about the other computing devices in the set and, in particular, a time and location of a last successful connection between the computing device and one or more of the other computing devices. This “data” (or data set) is sometimes referred to herein as a “connection table.” The data at a particular computing device is updated (e.g., modified, edited, changed, augmented, supplemented, as the case may be) as computing devices in the set move out of communication range with one another. In particular, preferably the data at the particular computing device is updated (a) when the particular computing device itself loses contact with one of the other computing devices in the set, or (b) when the particular computing device receives a notification from one of the other computing devices that such other computing device has lost contact with a computing device that the other computing device had been in contact with. In this manner, the particular computing device in the set obtains a time and location of some last successful connection with respect to some other computing device in the set even if the latter computing device is not (or indeed never was) directly connected to the particular computing device. Stated another way, the computing devices that are networked together share (among each other) “last successful connection” data indicating when a particular computing device in the set last had a successful connection to some other computing device.

Subsequently, and upon receipt of a request to locate a lost computing device that is one of the set of computing devices, an exact or last known location of the lost computing device is identified using the updated data maintained at the device that receives the request. This updated data identifies the location either directly (when the computing device that receives the request had the last successful connection to the lost computing device), or indirectly, by identifying a second computing device that had a last successful connection to the lost computing device. If the computing device that receives the request to locate the lost computing device does not have the most current location information for the lost computing device, it then queries the second computing device to obtain the last known location of the lost computing device.

The term “lost” as used herein is not limited to the situation where a device cannot be found, but it should also be construed to extend to a lost connection, such as when a device moves out of a communication range. A “lost” device is sometimes referred to as “missing.”

The term “location” or “whereabouts” as used herein is not limited to a precise physical location (such as determined by x, y and z coordinates), but it may also include an area or region surrounding a physical location or in which the physical location may be found. A “current” location may be an actual location, or more typically, a relative location.

A “time” as used herein need not be limited to a precise clock time, but it may also include a defined temporal period (e.g., a minute, an hour, a day, a week, etc.) in which the clock time may be found. A “current” time may be an actual time or, more typically, a relative time.

A “request” to locate (find) a lost device may be manual (on demand), automatic, or under program control.

A “last successful connection” may occur at a “time” certain or within a time period, and optionally in association with a “location” as defined herein.

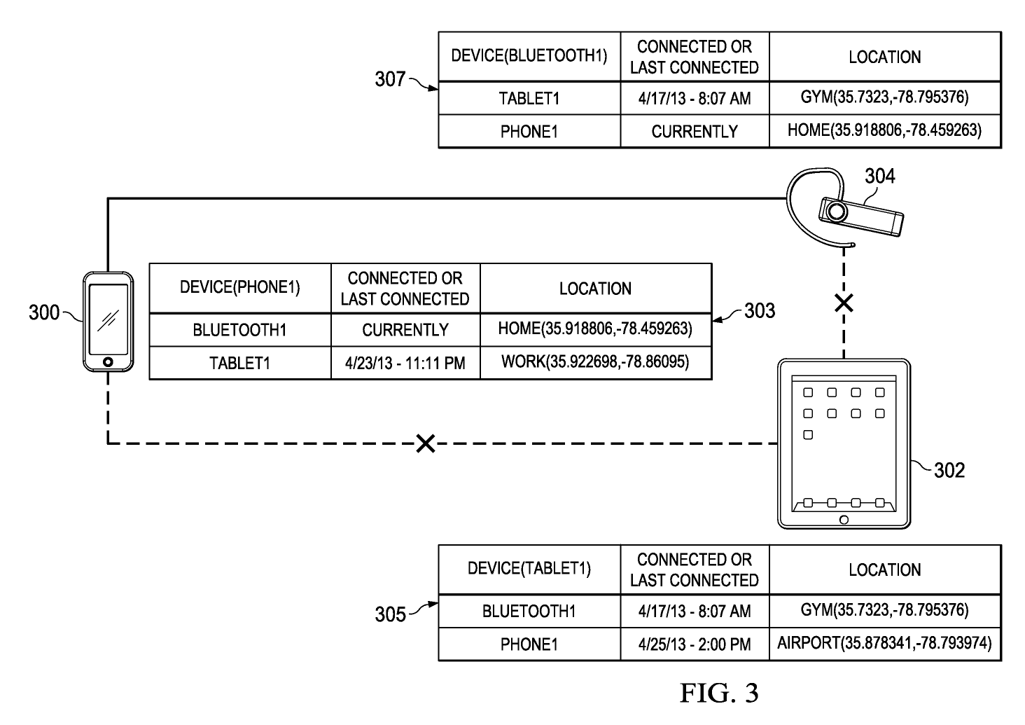

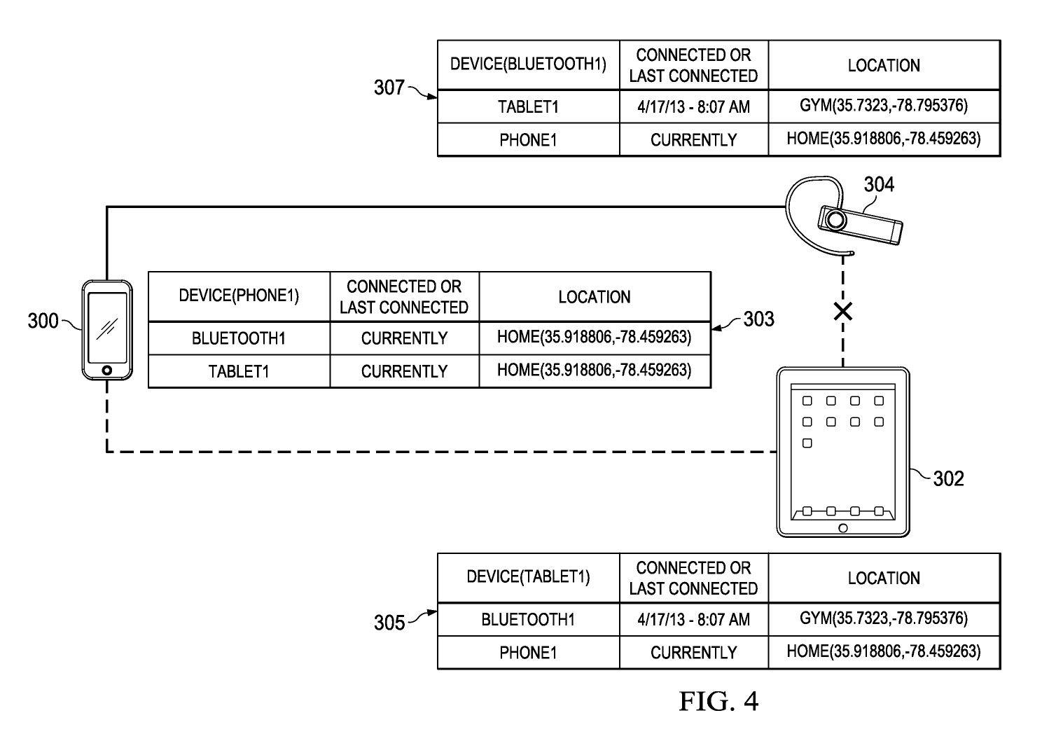

FIG. 3 illustrates a set of computing devices and how these devices track usage and awareness of each other. In this example scenario, the user has three (3) devices, a smartphone 300, a tablet 302, and a headset 304. Each computing device maintains data in the form of a connection table that identifies a time and location of a last successful connection between the computing device and one or more of the other computing devices. Thus, smartphone 300 includes connection table 303 that identifies the headset (Bluetooth1) and the tablet 302 (Tablet1). The headset is shown as being currently connected at the user's home (“Home” with latitude and longitude coordinates specified as shown). The connection table 303 also shows the tablet's last connected time (a date/time), and the location of last connection (the user's “Work” once again with latitude and longitude coordinates specified). Likewise, the tablet 302 has its own connection table 305, and the headset 304 has its own connection table 307. In this example scenario, the smartphone is in contact with the headset, which has lost connectivity with the tablet. The smartphone also has lost connectivity with the tablet. In FIG. 4, the user's smartphone 300 has re-established connectivity with the user's tablet 302. Thereafter, the connection tables 303 and 305 include the information shown.

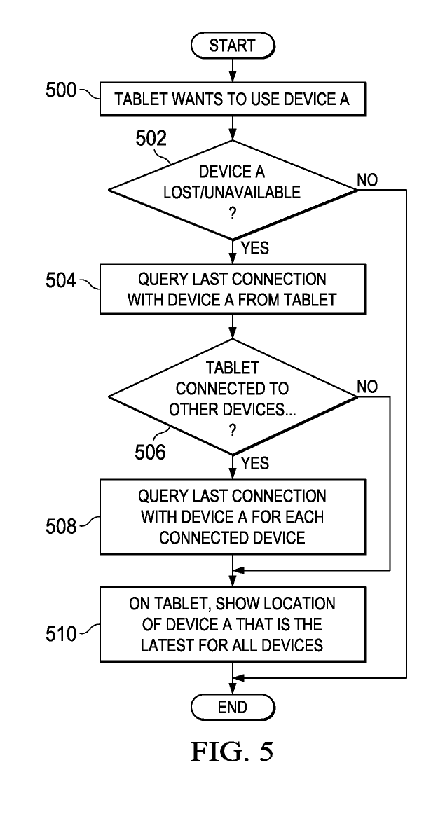

To facilitate locating of lost devices, data in a computing device's connection table is updated, preferably upon two (2) distinct types of events: (a) when the computing device itself loses contact with one of the other computing devices in the set, and (b) when the computing device receives a notification from a second computing device that the second computing device has lost contact with a third computing device in the set. In addition, the data in a computing device's connection table may be updated (such as shown in comparing FIG. 3 and FIG. 4) when a device re-establishes a lost connection with another computing device in the set. By updating the connection tables in this manner, it then becomes possible for a particular computing device to identify the current or last known location of one of the other devices (the lost or missing one). FIG. 5 describes a process flow for this operation, as is now described.

For simplicity, FIG. 5 is described in the context of the set of computing devices in the particular state shown in FIG. 4. This is merely for explanatory purposes and should not be construed as limiting. FIG. 5 assumes that the computing devices each maintain an up-to-date connection table, as has been described. Assume further that tablet 302 wants to use the headset (Device A, as described in FIG. 5). The routine then starts at step 500. At step 502, the tablet's device location function (typically software executed by a hardware processor on the device) tests to determine whether the headset is lost or unavailable. If the outcome of the test at step 502 is negative, the routine branches and ends, as the headset is not lost and the tablet can connect or re-connect without more. If, however, the result of the test at step 502 indicates that the headset is lost or otherwise unavailable, the routine continues at step 504 to query for the tablet's last connection with the headset. This information will be available from the tablet's own connection table. A test is then performed at step 506 to determine whether the tablet is connected to other devices. This step is performed because, even though the table may have its last connection information, other computing devices in the set may have more current information about the lost devices. If the outcome of the test at step 506 is negative, then the tablet itself has the most recent information of interest; the routine then branches to step 510, and the user is provided an indication of the headset's location that is the latest for all devices. The indication provided to the user may be of any type, e.g., a map with the device's location overlaid, an SMS or MMS message indicating (or including a link to) the location, an email indicating (or including a link to) the information, an audible (spoken) message, a beep or series of beeps whose frequency varies as the user moves closer to the device, etc. The particular form of this location information is not a limitation of this disclosure and will typically depend on the nature and type of computing device (and possibly the user's interaction history with the device). Referring back to FIG. 5, if the outcome of the test at step 506 is positive, the routine continues at step 508 with the table querying each connected device and asking for that connected device's last connection with the headset. Based on the results obtained, the tablet can then provide the location information in step 510, as has been described. Thus, in step 508, the computing device at which the request to locate originates seeks out last connection information from one or more other computing devices (which each maintain their own connection table for this purpose). In this manner the tablet locates the headset and can then re-establish its connection thereto. This completes the process.

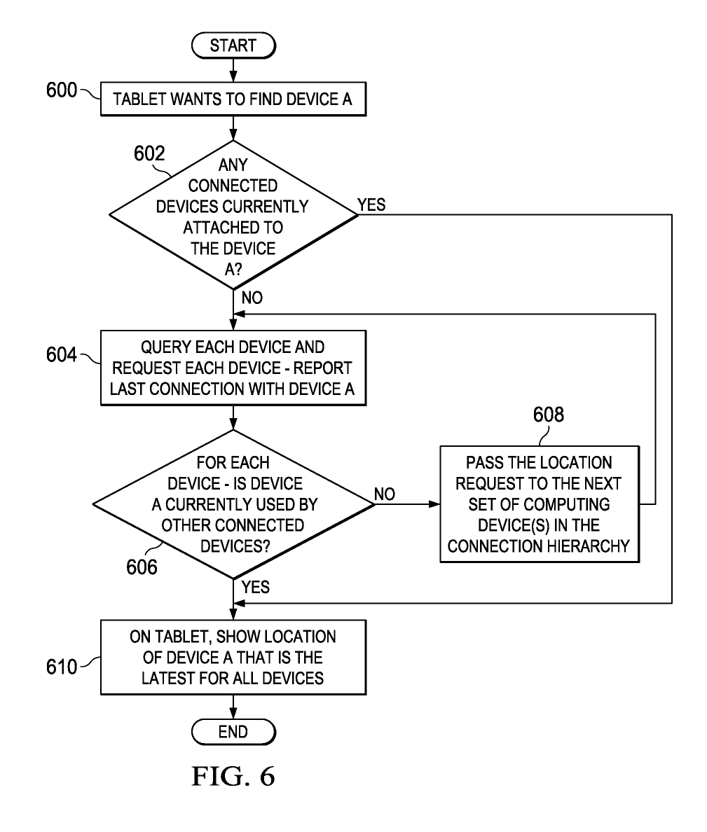

FIG. 6 illustrates a variant scenario that may occur when none of the computing devices connected to the tablet are currently connected to the target device (the headset). Once again, this is just an example scenario. As before, FIG. 6 assumes that the computing devices each maintain an up-to-date connection table, as has been described. Assume further once again that tablet 302 wants to use the headset (Device A, as described in FIG. 6). The routine then starts at step 600. At step 602, the tablet's device location function (software executed by a hardware processor on the device) tests to determine whether any connected devices are currently attached to the headset. If the outcome of the test at step 602 is branches to step 610, where the tablet display (or other output interface) is updated to show the location of the headset that is the latest for all of the devices. This was the operation described with respect to FIG. 5. If, however, the result of the test at step 602 indicates that none of the connected devices is attached to the headset (the lost device), it then becomes necessary to perform additional searching. To that end, the routine continues at step 604 to initiate a downstream query operation. In step 604, the requesting computing device initiates a process to begin querying the connected device, potentially one-by-one, to request that the connected device report its last connection with the headset and, as needed, pass the request to other connected devices. Depending on the state of the connection tables, some of this processing may be omitted or necessary. At step 606, and beginning with a first connected device, the routine tests to determine whether the headset is currently being used by one or more other connected devices. If so, the routine branches to step 610 previously described. If, however, the outcome of the test at step 606 is negative, the routine branches to step 608 to go to the next device; the routine then returns to step 604 and the process cycles. When all the computing devices have been checked, the routine continues at step 610, as described. In this manner the tablet locates the headset and can then re-establish its connection thereto. This completes the process.

A skilled person will appreciate that, depending on the nature of the computing devices involved (and their type of usage), the relative degree of movement among the devices may be static; as such, and given the updating function described, the information in the connection tables thus may become synchronized. If the connection tables across the then connected computing devices are identical, a particular device's connection table should include all information necessary for that computing device to identify a current or last known location for a missing device. Given the relative movement of the computing devices will be the usual case, however, typically connection tables across the set of computing devices will not be synchronized (or at least for any substantial period of time).

Particular computing devices may execute authentication or authorization functions before they become members of the set of computing devices for which the subject technique may be used. The authentication/authorization functions may use a central authority or operate peer-to-peer, or in any combination thereof. A computing device thus may only become one of the set of computing devices that keep track of one another if it is authenticated and/or authorized to do so. Typically, a user will control which devices are permitted to join the set of computing devices, which preferably each include the mobile app (or its equivalent) that enables the described functionality.

The approach herein provides significant advantages. It enables a user to quickly locate a lost device that is connectable to multiple of the user's computing devices (e.g., a smartphone, and a tablet), or where the lost device is shared among multiple users each having their own computing device. The latter scenario is quite useful where the lost device is shared among the multiple users but one of the users has misplaced it and the other user needs to find it. The device location technique enables a user looking for a lost device to find it even though the actual computing device(s) in the user's possession (e.g., the one that needs to locate the lost device) is not able to communicate with the lost device; by using the connection tables described, the user's current device can locate at least one other computing device that was last in communication with the lost device and then reach out to query that intermediary for the current or last known location of the lost device. This “relaying” of the location request can continue as necessary until the lost device's location or last known location can be ascertained and returned to the querying device.

The approach thus enables quick location of devices by interacting with an inquiring of other devices that had at some point communicated with the missing device. The approach takes advantage of the set of computing devices that keep track of each other; the update to a device's “local” connection table enables the device to make note of a last point and time of lost communication with some device in the set, or to identify a computing device in the set that has such data. The technique provides for an efficient way to query the devices that are within communication range about the location of the missing device and, if necessary, the last point of contact with the missing device. As noted, the approach advantageously enables devices that are within communication range broadcast a request (to locate a missing device) to other devices, and to relay back their responses.

Thus, for example, a user may have intentionally left a Bluetooth device at his or her home. When the user is at a remote location, the mobile device in the user's possession remembers the last location of the Bluetooth device. Assume, however, that the user's toddler at home who plays with the Bluetooth device misplaces it. Using the described technique, the user's mobile device (even at the remote location) reaches out to other of the user's (or other permitted) computing devices with which it can communicate to ask for the location of the Bluetooth device. Those other devices, if they are not able to locate the Bluetooth device, may also relay the query to still other devices with which they can communicate (now two steps removed from the user's original device from which the “find” query originates). The user's mobile device is then provided with more accurate information as to the whereabouts or last known whereabouts of the Bluetooth device.

As another example, assume a user's Bluetooth device can be connected to the user's first computing device (a smartphone), and to the user's second computing device (a pervasive computing platform/system operating in the user's automobile). The user leaves his or her house and takes the train to work, taking the smartphone but not the headset. Now, the user's adult daughter takes the headset and drives the user's car to a second location, where she inadvertently leaves the headset. When the user comes home from work, the smartphone seeks to locate the headset automatically. The smartphone's connection table shows the headset being located at home, while the automobile's connection table shows the headset being located at the second location. Because the smartphone's connection table cannot provide the location, the smartphone queries all (or at least some) other connected devices about the headset. The smartphone finds that the user's automobile had the headset last (e.g., at GPS coordinates that correspond to the second location). The smartphone then has two pieces of information, the last location and potentially the last use (in the automobile).

Of course, the above scenarios are merely exemplary and should not be taken to limit the disclosure. As noted, the techniques may be used with any type of computing device, any underlying network transport, and the like.

As another example, assume a user's portable heart rate monitor is connected to her tablet device. The user leaves her home in the morning with her smartphone, but without connecting the heart rate monitor to the smart phone. At this point the smartphone and heart rate monitor are not aware of each other. The user, however, can determine the location of the heart rate monitor (using the smartphone) by asking any other devices within range of the smartphone, and she can also determine the last time each device was connected to the heart rate monitor (the lost device). Thus, if the user's laptop was connected to the heart rate monitor say, one week earlier, the user's smartphone can request information from the laptop, which would respond “connected 7 days ago” or the like. If the battery dies on the heart rate monitor after the user leaves home, when she returns the smartphone and the tablet share information, and the tablet will report it was connected to the monitor in the morning (say, before the user left) and provide that location.

The functionality described above may be implemented as a standalone approach, e.g., a software-based function executed by a processor. The particular hardware and software implementation details described herein are merely for illustrative purposes are not meant to limit the scope of the described subject matter.

More generally, computing devices within the context of the disclosed subject matter are each a data processing system (such as shown in FIG. 2) comprising hardware and software, the device may communicate with other devices and systems over a network, such as the Internet, an intranet, an extranet, a private network, or any other communications medium or link.

Still more generally, the subject matter described herein can take the form of an entirely hardware embodiment (including firmware), an entirely software embodiment or an embodiment containing both hardware and software elements. In a preferred embodiment, the device location function is implemented in software, which includes but is not limited to firmware, resident software, microcode, and the like. Furthermore, as noted above, the entropy pooling functionality can take the form of a computer program product accessible from a computer-usable or computer-readable medium providing program code for use by or in connection with a computer or any instruction execution system. For the purposes of this description, a computer-usable or computer readable medium can be any apparatus that can contain or store the program for use by or in connection with the instruction execution system, apparatus, or device. The medium can be an electronic, magnetic, optical, electromagnetic, infrared, or a semiconductor system (or apparatus or device). Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD. The computer-readable medium is a tangible item.

The computer program product may be a product having program instructions (or program code) to implement one or more of the described functions. Those instructions or code may be stored in a computer readable storage medium in a data processing system after being downloaded over a network from a remote data processing system. Or, those instructions or code may be stored in a computer readable storage medium in a server data processing system and adapted to be downloaded over a network to a remote data processing system for use in a computer readable storage medium within the remote system.

In a representative embodiment, the connection table management and lost device location functionality are implemented in a special purpose computing entity, preferably in operating system or application software executed by one or more processors (see, e.g., FIG. 2). The connection table may be an in-memory data structure, written to cache or disk, or some combination thereof. These techniques (or portions of them) also may be implemented in hardware (e.g., special-purpose chips, field-programmable devices such as FPGA, FPLA or the like) or firmware. When implemented in software, the software is maintained in one or more data stores or memories associated with the one or more processors, and the software may be implemented as one or more computer programs. Collectively, this special-purpose hardware and software comprises an identity management and access control mechanism for the mobile device as described.

While the techniques are described in the context of a mobile device, they may be used in other devices including, without limitation, desktop computers that include touchpads as input devices, in automobile man-machine interfaces, in general appliances that include touchpads or similar input screens, and the like, of wherever such one or more of such devices or systems are in relative (physical and/or temporal) movement to one another. The functions described herein (in whole or in part) may be implemented as an adjunct or extension to an existing application, device, system or process.

While the above describes a particular order of operations performed by certain embodiments of the invention, it should be understood that such order is exemplary, as alternative embodiments may perform the operations in a different order, combine certain operations, overlap certain operations, or the like. References in the specification to a given embodiment indicate that the embodiment described may include a particular feature, structure, or characteristic, but every embodiment may not necessarily include the particular feature, structure, or characteristic.

Finally, while given components of the system have been described separately, one of ordinary skill will appreciate that some of the functions may be combined or shared in given instructions, program sequences, code portions, and the like.

Any application or functionality described herein may be implemented as native code, by providing hooks into another application, by facilitating use of the mechanism as a plug-in, by linking to the mechanism, and the like.

The techniques disclosed herein are not limited to a mobile device having the characteristics of the type described, but this will be a typical implementation. As noted, the above-described function may be used in any system, device, sub-system, site, or the like wherein computing devices use networking technology to communicate with one another. The computing devices may be mobile-based, or fixed (e.g., an appliance). Generalizing, a computing device it may any pervasive computing device regardless of how supported.

Having described our invention, what we now claim is as follows:

1. A method operative at a computing device, the computing device being one of a set of computing devices, each computing device in the set including networking technology, comprising:
maintaining data about one or more other computing devices in the set, the data identifying a time and location of a last successful connection between the computing device and the one or more of the other computing devices;
updating the data as computing devices in the set move out of communication range with one another, wherein data is updated upon an event that is one of: (a) when the computing device itself loses contact with one of the other computing devices in the set, and (b) when the computing device receives a notification from a second computing device that the second computing device has lost contact with a third computing device in the set;
upon receipt of a request to locate a lost computing device that is one of the set of computing devices, using the updated data to identify a last known location of the lost computing device;
wherein at least one of the steps is implemented in software executing in a hardware element.

2. The method as described in claim 1 wherein the last known location of the lost computing device is identified from the updated data directly when the computing device that receives the request had the last successful connection to the lost computing device.

3. The method as described in claim 1 wherein the last known location of the lost computing device is identified indirectly by identifying a second computing device that had a last successful connection to the lost computing device and querying the second computing device to obtain the last known location of the lost computing device.

4. The method as described in claim 1 wherein the notification is received periodically or upon demand.

5. The method as described in claim 1 further including providing an indication of the location of the lost computing device.

6. The method as described in claim 5 wherein the indication of the location is provided by one of: a map overlaid with the location, a message including information identifying the location, and a link including information identifying the location.

7. An apparatus associated with a computing device having networking technology, the computing device being one of a set of computing devices, each computing device in the set including networking technology, comprising:
a processor;
computer memory comprising computer program instructions, the computer program instructions operative to locate a lost device, the computer program instructions comprising:
program code to maintain data about one or more other computing devices in the set, the data identifying a time and location of a last successful connection between the computing device and the one or more of the other computing devices;
program code to update the data as computing devices in the set move out of communication range with one another, wherein data is updated upon an event that is one of: (a) when the computing device itself loses contact with one of the other computing devices in the set, and (b) when the computing device receives a notification from a second computing device that the second computing device has lost contact with a third computing device in the set;
program code operative upon receipt of a request to locate a lost computing device that is one of the set of computing devices, to use the updated data to identify a last known location of the lost computing device.

8. The apparatus as described in claim 7 wherein the last known location of the lost computing device is identified from the updated data directly when the computing device that receives the request had the last successful connection to the lost computing device.

9. The apparatus as described in claim 7 wherein computer program instructions further include:
program code to identify a second computing device that had a last successful connection to the lost computing device, and
program code to query the second computing device to obtain the last known location of the lost computing device.

10. The apparatus as described in claim 7 wherein the notification is received periodically or upon demand.

11. The apparatus as described in claim 7 wherein the computer program instructions further include program code to provide an indication of the location of the lost computing device.

12. The apparatus as described in claim 11 wherein the indication of the location is provided by one of: a map overlaid with the location, a message including information identifying the location, and a link including information identifying the location.

13. A computer program product in a non-transitory computer readable medium for use in a computing device, the computing device being one of a set of computing devices, each computing device in the set including networking technology, the computer program product holding computer program instructions operative to locate a lost device, the computer program instructions comprising:
program code to maintain data about one or more other computing devices in the set, the data identifying a time and location of a last successful connection between the computing device and the one or more of the other computing devices;
program code to update the data as computing devices in the set move out of communication range with one another, wherein data is updated upon an event that is one of: (a) when the computing device itself loses contact with one of the other computing devices in the set, and (b) when the computing device receives a notification from a second computing device that the second computing device has lost contact with a third computing device in the set;
program code operative upon receipt of a request to locate a lost computing device that is one of the set of computing devices, to use the updated data to identify a last known location of the lost computing device.

14. The computer program product as described in claim 13 wherein the last known location of the lost computing device is identified from the updated data directly when the computing device that receives the request had the last successful connection to the lost computing device.

15. The computer program product as described in claim 13 wherein computer program instructions further include:
program code to identify a second computing device that had a last successful connection to the lost computing device, and
program code to query the second computing device to obtain the last known location of the lost computing device.

16. The computer program product as described in claim 13 wherein the notification is received periodically or upon demand.

17. The computer program product as described in claim 13 wherein the computer program instructions further include program code to provide an indication of the location of the lost computing device.

18. The computer program product as described in claim 17 wherein the indication of the location is provided by one of: a map overlaid with the location, a message including information identifying the location, and a link including information identifying the location.
